(19) United States
(12) Patent Application Publication
(10) Pub. No.: US 2017/0249451 A1
(43) Pub. Date: Aug. 31, 2017

(54) BIOMETRIC AUTHENTICATION SYSTEMS, METHODS, AND MEDIA

(71) Applicant: Aneta ANDREEVA, Wilmington, MA (US)

(72) Inventor: Aneta ANDREEVA, Wilmington, MA (US)

(21) Appl. No.: 15/519,827

(22) PCT Filed: Oct. 16, 2015
(86) PCT No.: PCT/US15/56113

§ 371 Date: Apr. 17, 2017

Related U.S. Application Data
(60) Provisional application No. 62/064,968, filed on Oct. 16, 2014.

(51) Int. Cl. G06F 21/32; G06K 9/00

(52) U.S. Cl. CPC G06F 21/32; G06K 9/00006; G06K 9/00221; G06K 9/00597

(57) ABSTRACT

Systems, methods, and non-transitory computer-readable media for biometric authentication of people are provided. The system may be a stand-alone unit for biometric authentication, or may be integrated into consumer or household devices, point-of-sale devices, or security systems for controlling access to a facility or area. The system may include a plurality of supplemental input devices, such as a keypad, keyboard, or user-supplied device, to augment the biometric authentication. When the system is used by a user, it carries out at least one method of authenticating the identity of the user by matching biometric information acquired from the user to a database of authorized users. Such a database may be local to the device used to acquire the user's biometric information, or may be remote, or the authentication information on authorized users may be stored both locally and remotely.

### FIELD OF THE INVENTION

The presently disclosed subject matter relates to biometric authentication, and more specifically, to systems, methods, and non-transitory computer-readable media for authenticating the identity of an individual using biometric information supplemented with additional identifying information, and using that authenticated identity to trigger one or more actions or permissions.

### BACKGROUND OF THE INVENTION

Biometric authentication is the authentication of a person's identity through the use of biometric information. Biometric information, or biometrics, are measures of characteristics or traits of a person, which may be physiological or behavioral. Physiological characteristics that can be measured for biometric authentication include facial features and shape, fingerprint patterns, hand shape and geometry, vein patterns, iris patterns, retinal patterns, DNA, scent, a person's voice, and a person's written signature. Biometric authentication attempts to link a person to an authentication event, in which a person scans a biometric characteristic, such as any of the above. To do so, a biometric authentication system compares the acquired biometric information to information stored in a database, attempting to find a match above a level of statistical significance to a particular individual.

Advantages of biometric authentication include an increased level of security and certainty in comparison to non-biometric authentication, as biometric authentication measures biometric characteristics that are almost completely unique to a person (barring mistakes or fraud, which is more difficult that with non-biometric authentication), unlike passwords or other forms of non-biometric identification, which can be stolen or guessed. Biometric authentication is also more convenient than traditional authentication, as there is nothing that a user needs to remember or bring. Lastly, biometric authentication inherently creates an audit trail, again adding to its advantage over non-biometric authentication.

Biometric authentication solutions exist and are in use for a range of personal identity authentication applications spanning secure access to buildings and other facilities, data privacy, financial transactions, commercial applications, sign-on to computers, including workstations, laptops, and mobile devices, and sign-on to applications, websites, and remote computer servers. Biometric authentication can be used as a standalone security technology, or in combination with non-biometric authorization technologies, such as photo ID cards, radio-frequency ID cards, digital identifiers, passwords or passphrases, or encryption keys. Using biometric authentication to verify a person's identity is becoming convenient, but there are considerable improvements in convenience that could be realized in, among other aspects, ease of registration of authorized users, ease of operation, and ease of installation of biometric authentication system to new or existing items.

The relative lack of ease of use of biometric authentication systems, in all these aspects, is an obstacle to the widespread acceptance of biometric authentication. Furthermore, integration of biometric authentication into multiple forms and into common consumer goods, point-of-sale technologies, and security control points could be accelerated with biometric authentication devices that allow for easier use by consumers. Current biometric authentication systems are overly complicated for typical consumer use in applications including but not limited to cars, household locks and security systems, or payment at grocery stores or restaurants.

### SUMMARY OF THE INVENTION

The present invention meets all these needs, by disclosing systems, methods, and non-transitory computer-readable media for biometric authentication that are simple for any consumer to use. The inventive systems, methods, and non-transitory computer-readable media may be installed in a great range of applications, from settings requiring strong security such as airports or buildings, to consumer goods ranging from cars and household security systems or door locks, to computers, televisions, liquor cabinets, appliances, or payment systems such as those presently in use requiring credit cards or debit cards utilizing a magnetic stripe, a computer chip encoded with identifying information, or a RFID (radio-frequency identification) system allowing payment by scanning. At a high level of summary, the system comprises one or more biometric authentication scanner modules, at least one computer, and at least one input device. In some embodiments, the system also comprises a display and/or the ability to connect to the internet in conjunction with use of a plurality of remote servers or databases. An object of the invention is to provide a biometric authentication system, methods, and a non-transitory computer-readable medium that, when a user desires to register and control access to a service, a thing, or a place, enable simple and seamless biometric authentication and registration that may be embodied in a wide variety of devices and objects.

As a mid-level overview of the present invention, the presently disclosed invention facilitates improvements in convenience by providing simple and compact devices, methods, and non-transitory computer-readable media for biometric authentication that are easy for any user to operate. Such operation may include programming a device to recognize the biometric information of one or more users, or registering one or more users with a remote system. The present invention may be integrated into consumer goods or other items prior to sale, to allow full and seamless integration and use of biometric authentication in operating or unlocking the consumer good or service. Such integrated applications may include but are not limited to vehicles, computers, televisions, household appliances, locks for doors, motorcycles, or bicycles, and home security systems. The present invention provides additional improvements in convenience of biometric authentication systems in that it may be manufactured and sold in standalone embodiments that may be integrated into existing items by the user. Such use cases include but are not limited to adding locks or locking mechanisms to a household appliance or device that may or may not have a lock, but which a user desires to make more secure. Examples include cabinets for securing any potentially hazardous items including but not limited to power tools, firearms, knives, chemicals for cleaning, or liquor; appliances including but not limited to stoves, ovens, or blenders; and household locks. Any such applications of the present invention provide improved convenience over the present art.

Embodiments of the present invention further provide a non-transitory computer-readable medium storing computer-readable instructions that, when executed by a processor of an apparatus, instruct the processor to perform processes or methods which involve the exchange, gathering, storage, and/or processing of information related to i) registration of one or more users with a biometric authentication system; and/or ii) authentication of any such users by a biometric authentication system.

Lastly, the present invention provides improvement over the current state of the art of biometric authentication by simplifying installation (when the present invention is being retrofitted to an existing item), registration of a plurality of users in the biometric authentication database of the present invention, and set-up of the biometric authentication system, as described below in greater detail, so that any consumer can install and use the inventive systems, methods, and non-transitory computer-readable media without resort to overly complicated engineering or requirements.

These aspects of the present invention, and other disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; but, the presently disclosed subject matter is not limited to the specific methods and instrumentalities disclosed. In the drawings, like reference characters generally refer to the same components or steps of the device throughout the different figures. In the following detailed description, various embodiments of the present invention are described with reference to the following drawings, in which:

FIG. 1 shows a view of an exemplary embodiment of the system of the present invention.

FIG. 2 depicts an exemplary method of registration of an authorized user, shown from the perspective of the system.

FIG. 3 depicts an exemplary method of registration of an authorized user, shown from the perspective of a user device.

FIG. 4 depicts an exemplary method of registration of an authorized user, shown from the perspective of a third party.

FIG. 5 depicts an exemplary method of authentication of an authorized user, shown from the perspective of the system.

### DETAILED DESCRIPTION OF THE DRAWINGS

The presently disclosed invention is described with specificity to meet statutory requirements. But, the description itself is not intended to limit the scope of this patent. Rather, the claimed invention might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

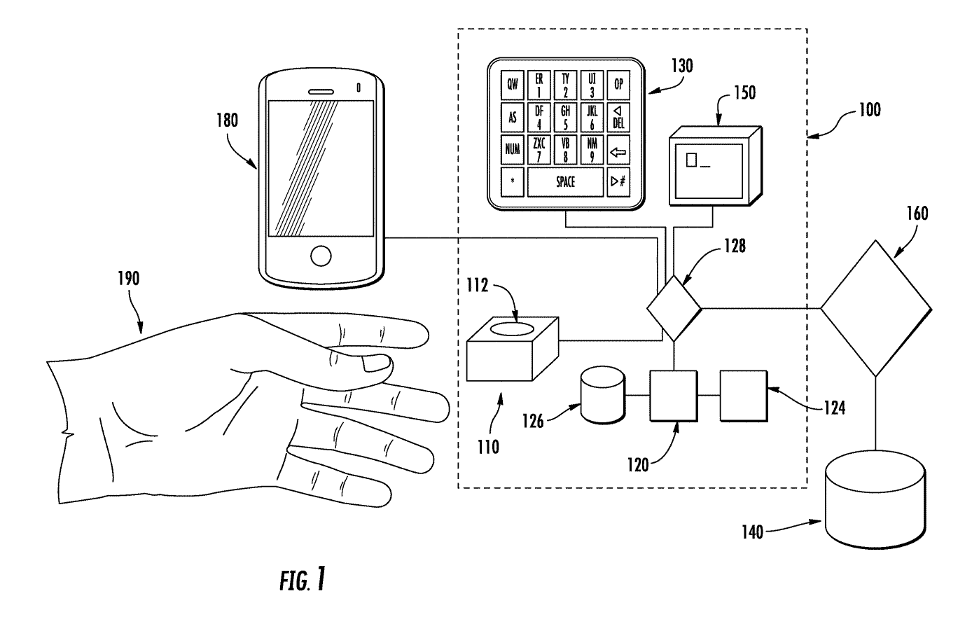

The present subject matter discloses systems, methods, and non-transitory computer-readable media for biometric authentication. As a mid-level overview, the present invention presents systems, methods, and computer-readable instructions that may be stored in non-transitory computer readable media, all of the foregoing enabling simple and convenient biometric authentication of a user for access to a device, location, or service. It has been found advantageous, as shown in FIG. 1, to have the biometric authentication system (“BAS”) 100 comprise a plurality of biometric information scanners 110, a plurality of central processing units (“CPU”) 120, a plurality of memory 124 units, a plurality of input/output 128 units, and a plurality of input devices 130. A biometric information scanner 110 further comprises a sensor 112 or a plurality of sensors 112, to be used by the user 190 to commence 530 a scan of the user biometric information 238, as described below in greater detail, to allow the BAS 100 to use the user biometric information 238 to attempt the initial biometric registration 200, registration 300, registration 400, and/or biometric authentication 500. Each of the plurality of input devices 130 may further comprise a plurality of discrete sensors 112, of the same type of sensor 112 or multiple types of sensors 112 in each of the plurality of input devices 130; each reference to an input device 130 in the present disclosure is to be understood to possibly include a plurality of sensors 112. Depending on the type of biometric information to be scanned, the sensor 112 may be, but is not limited to, an optical scanning pad (such as for authenticating biometric information using fingerprint patterns, hand shape and geometry, or vein patterns), an imaging laser and/or optical detector (such as for authenticating biometric information using facial features and shape, iris patterns or retinal patterns), a gene sequencer (such as for authenticating biometric information using DNA), a gas chromatograph or other instrument capable of chemical analysis (such as for authenticating biometric information using scent), a microphone (such as for authenticating biometric information using a person's voice), or a pressure-sensitive surface to write on (such as for authenticating biometric information using a person's written signature). In all the foregoing examples of a sensor 112 of various types and what types of biometric information an exemplary sensor may be used to scan or sense, the examples of types of biometric information are to be understood as non-exhaustive and non-exclusive lists, and that each exemplary type of sensor 112 listed may be used to scan or measure any other type of biometric information.

The BAS 100 may further comprise a plurality of internal databases 126. An internal database 126 may be used to store information on authenticated users 190 to permit the BAS 100 to authenticate 500 a user 190 locally, as described in greater detail below, without need to access or communicate with a remote database or server system. In some embodiments of the present invention, the input/output 128 units may communicate with a plurality of remote databases 140 using a network 160, or using other means not depicted in FIG. 1. It has been found advantageous to have the input/output 128 units configured to communicate with a plurality of biometric information scanners 110, a plurality of input devices 130, a plurality of displays 150, and/or a plurality of user devices 180. A remote database 140 may store information on a plurality of registered users 190, and the BAS 100 may authenticate 500 a plurality of users 190 based on information stored in a remote database 140, following an exemplary inventive method as described in greater detail below. It has been found advantageous to have the CPU 120, comprising a range of components as described above, be custom-built or purpose-built and assembled specifically for operation as part of the BAS 100. In other embodiments of the invention, the BAS 100 may comprise a CPU 120 which was not custom-built or purpose-built for operation as part of the BAS 100. Typically, the input/output 128 is a communication device, but it may be a write/read device for a computer-readable storage medium.

With further reference to FIG. 1, in some embodiments of the present invention, an input device 130 may be used to activate 510 the BAS 100, and/or to enter information further verifying the identity of the user 190 being authenticated. An input device 130 may also be used for registration methods 200, registration methods 300, or registration methods 400 of a user 190 to allow the BAS 100 to authenticate 500 the user 190 in the future. In another embodiment of the invention, a user device 180 may be used for any of the functions for which a input device 130 may be used. The connection between the user device 180 and the BAS 100 may be wired or wireless, following any communications protocol now known or later invented.

It has been found advantageous to have the BAS 100 further comprise a plurality of displays 150. A display 150 may be integral to the BAS 100 or may be separate and connected via a wired or wireless connection now known or later invented. A display 150 may be used for any of the communicative uses to which the user device 180 may be put, as described above, or for other uses, including but not limited to displaying prompts to a user 190, exhibiting 580 messages to the user 190, alerting 590 third parties with alert messages on authorized access to the item or place for which the BAS 100 is used to authenticate users 190 or on failed attempts at access, or for other purposes. In another embodiment of the invention, a user device 180 may be used for some or all of the functions of a display 150, in conjunction with a display 150 or in place of a display 150. It will be apparent to one skilled in the art that any of the embodiments of the present invention may be built as one physical unit, or as a plurality of physical units, including but not limited to separately building or enclosing the biometric information scanner 110, CPU 120, input device 130, display 150, internal database 126, and/or remote database 140.

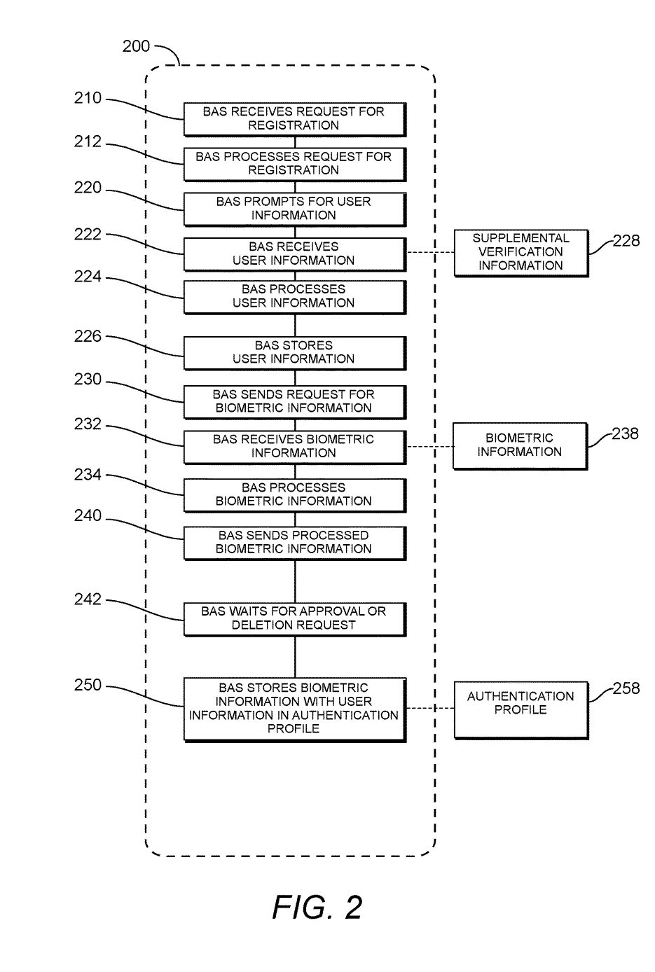

With reference to FIG. 2, an exemplary method of registration of an authorized user of the present invention is presented, shown from the perspective of the BAS 100. The registration method 200, and other registration methods 300 and registration methods 400, enable a transformation of physical biometric information into a digital record securely stored, and optionally associated with personal and secure user information, to create a personalized security profile suitable for authorizing access, purchases, or control, as described below in greater detail. It has been found advantageous to have the registration method 200 utilize the BAS 100 when a user 190 initiates registration.

In the method 200, the BAS 100 receives 210 a request for registration, via the input device 130 or the user device 180, to instruct the CPU 120 to prepare to register a new authorized user. A request for registration may be any exchange of information that instructs the BAS 100 to initiate the process of registering a user 190, culminating in creating an authentication profile 258, following the steps of the inventive methods, as described herein. The BAS 100 then processes 212 the request for registration, and prompts 220 for user information. The BAS 100 then receives 222 user information, including but not limited to, for instance, name, contact information, credit card or other financial account information when appropriate, information relevant to the thing, service, or place to which the user 190 wishes to control access, information related to emergency contacts or contacts which the BAS 100 should alert in the event of successful and/or failed attempts at authentication of a user 190, examples of which are described below in greater detail, and/or access desired, which may in some embodiments of the present invention be selected to be limited in time of access, duration of access, frequency of access, or other limitations which may be desirable, as will be apparent to one skilled in the art. It has been found advantageous to have such user information comprise supplemental verification 228 information, to be used during the authentication 500 method to further verify the identity of the user 190, as described below in greater detail. The BAS 100 processes 224 the user information, and stores 226 the user information in a plurality of internal databases 126 and/or remote databases 140.

The BAS 100 then sends 230 a request for a plurality of biometric information 238, to the input device 130 and/or the user device 180. Such biometric information 238 may come from the user's 190 finger, hand, eye, bodily material such as saliva containing a DNA sample, breath, or other sample from which user biometric information 238 will be recorded by the BAS 100 in contact with the sensor 112. The BAS 100 receives 232 the plurality of biometric information 238, and the BAS 100 processes 234 the plurality of biometric information 238.

The BAS 100 may then send 240 the plurality of biometric information 238 after processing, to the user device 180 and/or the input device 130 for review by the user 190, and the BAS 100 receives 242 an approval or a deletion request of the biometric information 238 from the user device 180 and/or the input device 130. If approved, the BAS 100 stores 250 the user biometric information 238 in the memory 124 and/or in a plurality of internal databases 126 and/or remote databases 140 along with the user information, including, it has been found advantageous, any supplemental verification 228 information, to create an authentication profile 258 of the user 190.

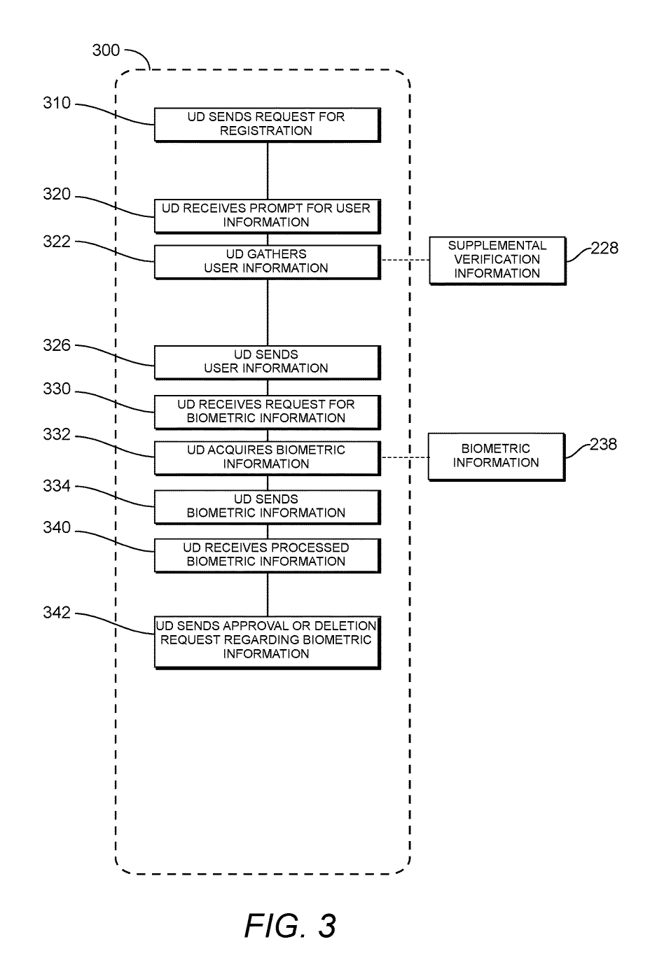

With reference to FIG. 3, an exemplary method of registration of an authorized user of the present invention is presented, shown from the perspective of the user device 180. It has been found advantageous to have the registration method 300 utilize the BAS 100 when a user 190 initiates registration. In the following description of the method 300, it will be understood by one of skill in the art that references to the user device 180 may, in alternative embodiments of the present invention, refer to an input device 130. In the exemplary method, the user device 180 sends 310 a request for registration to the BAS 100. The user device 180 thereafter receives 320 a prompt for user information, including but not limited to name, contact information, credit card or other financial account information when appropriate, information relevant to the thing, service, or place to which the user 190 wishes to control access, or information related to emergency contacts or contacts which the BAS 100 should alert in the event of successful and/or failed attempts at authentication of a user 190. The user device 180 then gathers 322 any such user information, and may also gather supplemental verification 228 information. The user device 180 thereafter sends 326 the user information and any supplemental verification 228 information to the BAS 100.

Later, the user device 180 receives 330 a request for biometric information 238 from the BAS 100. The user device 180 acquires 332 biometric information 238, and thereafter the user device 180 sends 334 the biometric information 238 to the BAS 100. It has been found advantageous to have, at a later point, the user device 180 receive 340 processed biometric information 238, and the user device 180 solicits an approval or a deletion request regarding the processed biometric information 238 from the user 190. The user device 180 thereafter sends 342 the approval or the deletion request regarding the processed biometric information 238 to the BAS 100.

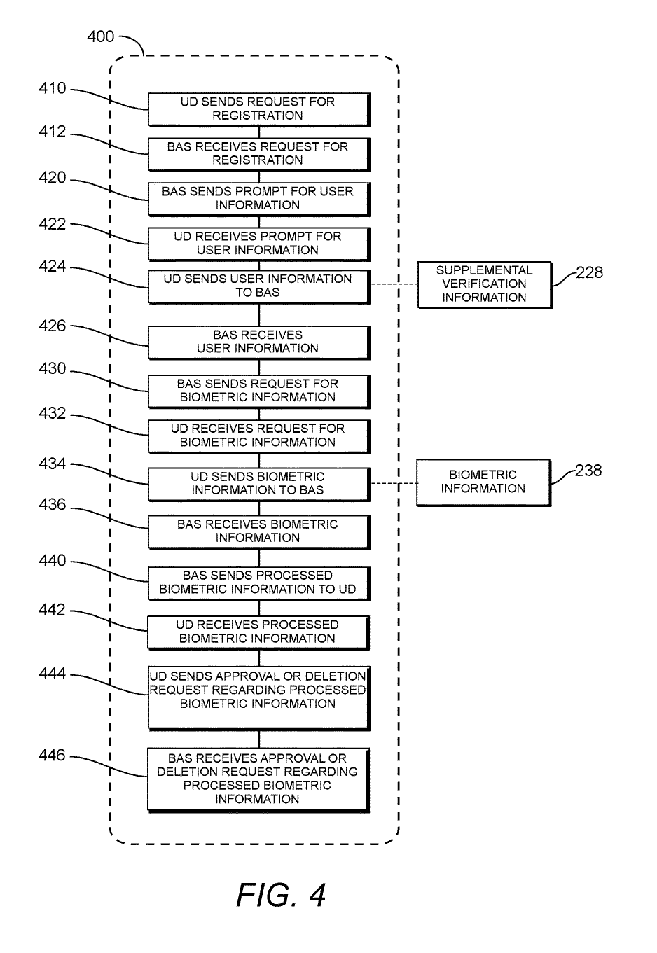

With reference to FIG. 4, an exemplary method of registration of an authorized user of the present invention is presented, shown from the perspective of a third party external to the BAS 100 and any user device 180. It has been found advantageous to have the registration method 400 utilize the BAS 100 when a user 190 initiates registration. In the following description of the method 300, it will be understood by one of skill in the art that references to the user device 180 may, in alternative embodiments of the present invention, refer to an input device 130. In the exemplary method, the user device 180 sends 410 a request for registration to the BAS 100. The BAS 100 receives 412 the request for registration. The BAS 100 thereafter sends 420 a prompt to the user device 180 and/or the input device 130 for user information, including but not limited to name, contact information, credit card or other financial account information when appropriate, information relevant to the thing, service, or place to which the user 190 wishes to control access, or information related to emergency contacts or contacts which the BAS 100 should alert in the event of successful and/or failed attempts at authentication of a user 190. The user device 180, and/or the input device 130, thereafter receives 422 the prompt for user information. The user device 180, and/or the input device 130, thereafter sends 424 any such user information, which may advantageously include supplemental verification 228 information, to the BAS 100. The BAS 100 receives 426 any such user information and any supplemental verification 228 information.

The BAS thereafter sends 430 a request for biometric information 238 to the user device 180 and/or the input device 130, which, as throughout this disclosure, one of skill in the art will understand to mean that the biometric information 238 is a plurality of biometric information. The user device 180 and/or the input device 130 receives 432 the request for biometric information 238, and thereafter the user device 180 and/or the input device 130 sends 434 the biometric information 238 to the BAS 100, and the BAS 100 receives 436 the biometric information 238. It has been found advantageous to have, at a later point, the BAS 100 sends 440 processed biometric information 238 to the user device 180 and/or the input device 130 for review by the user 190 along with a request for the user 190 to approve or request deletion of the biometric information 238. The user device 180 and/or the input device 130 receives 442 the processed biometric information 238 along with a request for the user 190 to approve or request deletion of the biometric information 238. The user device 180 and/or the input device 130 sends 444 an approval or a deletion request regarding the processed biometric information 238 to the BAS 100, and the BAS 100 receives 446 the approval or deletion request regarding the processed biometric information 238.

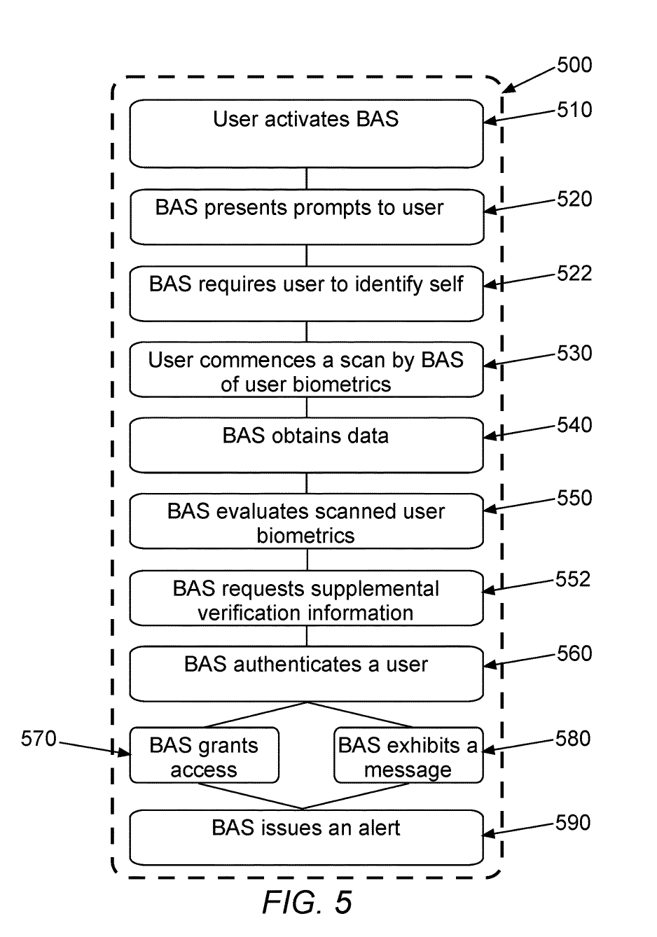

The inventive method of authentication 500 of registered and authorized users 190 that has been found advantageous is depicted in FIG. 5. The authentication method 500 enables a transformation of physical biometric information into a digital record for comparison with and analysis against a plurality of personalized security profiles, and optionally additionally gathers and transforms a user's knowledge and answers to questions into a digital record for comparison with the plurality of personalized security profiles, for authorizing access, purchases, or control, as described below in greater detail. A user 190 activates 510 the BAS 100, which may be by the user 190 inputting information or sending a signal from a user device 180 or from an input device 130 or from a sensor 112, as will be apparent to one of skill in the art, whereupon the BAS 100 presents 520 prompts to the user 190. The BAS 100 may present 520 prompts via a display 150 or a user device 180, to suggest to the user 190 what user biometric information 238 to scan, for instance, a particular finger or hand. In some embodiments of the present invention, the BAS 100 may present 520 prompts to the user 190 requiring 522 that the user 190 identify himself or herself prior to commencing 530 an acquisition of user biometric information 238, that is, to identify himself or herself without use of biometric information 238. In other embodiments of the present invention, the BAS 100 may present 520 prompts to the user 190 informing the user 190 to proceed to scanning user biometric information 238 without requiring 522 that the user 190 identify himself or herself first.

The user 190 then commences 530 an acquisition, which may be by a scan or other data acquisition method appropriate to the sensor 112 being utilized, of the user biometric information 238, as may be suggested by the BAS 100 in an embodiment of the invention that has been found advantageous. The BAS 100 obtains 540 the data derived from the acquisition of the user biometric information 238, and may move said data to the memory 124, and evaluates 550 the acquired user biometric information 238 against the biometric information stored 250 in a plurality of internal databases 126 and/or remote databases 140 as an authentication profile 258, such evaluating comprising comparing the acquired user biometric information 238 to i) the authentication profile 258 relevant to the user identified following the BAS 100 presenting prompts 520, or ii) to all stored authentication profiles 258, and assessing the extent to which identified features match. The BAS 100 authenticates 560 a user 190 if the evaluation 550 results of the comparison of the user biometric information exceed a first certain defined level of statistical certainty. It has been found advantageous to have the BAS 100 request 552 the supplemental verification 228 information from the user 190 if the evaluation 550 results of the user biometric information exceed a second certain defined level of statistical certainty. In such embodiments of the present invention, the BAS 100 authenticates 560 a user 190 if the supplemental verification 228 information matches with a third certain defined level of statistical certainty, which may be an exact match, with the supplemental verification 228 information stored with the authentication profile 258 of the user 190, and the evaluation 550 results of the user biometric information exceed the second certain defined level of statistical certainty.

If the BAS 100 authenticates 560 the user 190, the BAS 100 grants 570 the user 190 access to the item (an object, a service, an area, or other thing) being secured by the BAS 100, such as by operating or opening a device, thing, object, application, or gate. If the user 190 does not pass the attempt by the BAS 100 to authenticate 560 the user 190, the BAS 100 may exhibit 580 a message to the user 190; which exhibit 580 of a message may be implemented via the display 150 and/or a user device 180, and which message may inform the user 190 that the BAS 100 does not authenticate 560 the user 190, and/or inform the user 190 of any other information.

In some embodiments of the present invention, in the event that the BAS 100 does not authenticate 560 the user 190, the BAS 100 may alert 590 to a definable group, which group may comprise a plurality of authorized users 190 and/or emergency response personnel including but not limited to a police force, state troopers, sheriff's office, other state or Federal agencies, or one or more private security companies or other entities, of a user's failed attempt at authentication 560 via the BAS 100. It has been found advantageous to have the BAS 100, in the event of a successful authentication 560 of a user 190, alert 590 to a definable group, which group may comprise a plurality of authorized users 190, and/or other individuals or entities, as described above. A user's preferences for such alerts 590 by the BAS 100 may be set during the registration 200 procedure, as described above.

One or more of the above-described acts or methods or method steps may be encoded as computer-readable instructions executable by processing logic. The computer-readable instructions may be stored on or in one or more non-transitory computer-readable media. One or more of the above-described acts or methods or method steps may be performed in a suitably-programmed electronic device, including but not limited to a device meeting the description of the BAS 100 disclosed herein.

A non-transitory computer-readable medium storing a biometric authentication and registration program, according to yet another aspect of the invention, is a non-transitory computer-readable medium storing instructions for a biometric authentication and registration program causing a computer or electronic processing system to execute: a step of receiving a request for registration of a user 190; a step of processing the request for registration; a step of generating a prompt for user information; a step of receiving the user information; a step of processing the user information; a step of storing the user information; a step of requesting biometric information 238; a step of receiving the biometric information 238; a step of processing the biometric information 238; optionally a step of sending the processed biometric information 238 for review; optionally a step of receiving approval or a deletion request regarding the processed biometric information 238; and a step of storing the biometric information 238 with the user information to create an authentication profile 258 related to the user 190.

A non-transitory computer-readable medium storing a biometric authentication and registration program, according to yet another aspect of the invention, is a non-transitory computer-readable medium storing instructions for a biometric authentication and registration program causing a computer or electronic processing system to execute: a step of activating a BAS 100; a step of presenting prompts to a user 190; optionally a step of requiring the user 190 to identify himself or herself prior to commencing the acquisition of user biometric information 238; a step of commencing an acquisition of user biometric information 238; a step of obtaining the data derived from the acquisition of the user biometric information 238; a step of evaluating the acquired biometric information 238 against stored biometric information; optionally a step of requesting supplemental verification 228 information from the user 190 if the evaluation results of the user biometric information 238 exceed a second certain defined level of statistical certainty; a step of authenticating a user 190 if the evaluation results of the user biometric information exceed a first certain defined level of statistical certainty; optionally a step of authenticating a user 190 if i) the supplemental verification 228 information matches with a third certain defined level of statistical certainty with the supplemental verification 228 information stored with the authentication profile of the user, and ii) the evaluation results of the user biometric information 238 exceed the second certain defined level of statistical certainty; optionally a step of granting access to the item being secured; optionally a step of exhibiting a message to the user 190; and optionally a step of alerting a definable group.

The various methods described above may be implemented by computer-executable instructions, such as program modules, executed by a conventional or purpose-built computing device. Generally, program modules include routines, programs, objects, components, data structures, etc. that performs particular tasks or implement particular abstract data types. Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

The computer device may comprise or consist of a general-purpose computing device in the form of a computer including a processing unit, a system memory, and a system bus that couples various system components including the system memory to the CPU 120. Computers typically include a variety of computer-readable media that can form part of the system memory and be read by the CPU 120. By way of example, and not limitation, computer readable media may comprise computer storage media and communication media. The system memory 124 may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

Any suitable programming language may be used to implement without undue experimentation the data-gathering and analytical functions described above. Illustratively, the programming language used may include assembly language, Ada, Basic, C, C++, C#, COBOL, Forth, FORTRAN, Java, Lisp, Modula-2, Pascal, Prolog, Python, and/or JavaScript for example. Further, it is not necessary that a single type of instruction or programming language be utilized in conjunction with the operation of the system and method of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The CPU 120 that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The network 160 over which communication takes place may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Certain embodiments of the present invention were described above. From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. It is expressly noted that the present invention is not limited to those embodiments described above, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, I claim:

1. A biometric authentication system for biometric registration and authentication of a user, the biometric authentication system comprising:
a plurality of biometric information scanners,
the plurality of biometric information scanners further comprising a plurality of sensors;
a plurality of central processing units;
a plurality of memory units;
a plurality of input/output units; and
a plurality of input devices.

2. The biometric authentication system of claim 1, in which the plurality of input devices further comprises a plurality of discrete sensors.

3. The biometric authentication system of claim 1, in which the biometric authentication system further comprises a plurality of internal databases.

4. The biometric authentication system of claim 1, in which the input/output units communicate with a plurality of remote databases using a network.

5. The biometric authentication system of claim 1, in which the biometric authentication system further comprises a plurality of displays.

6. The biometric authentication system of claim 1, in which the input/output units are configured to communicate with the plurality of biometric information scanners, the plurality of input devices, a plurality of displays, and/or a plurality of user devices.

7. A method for registration of an authorized user of a biometric authentication system to create an authentication profile, the method comprising:
the biometric authentication system receiving a request for registration;
the biometric authentication system processing the request for registration;
the biometric authentication system prompting for user information;
the biometric authentication system receiving user information;
the biometric authentication system processing the user information;
the biometric authentication system storing the user information;
the biometric authentication system sending a request for a plurality of biometric information;
the biometric authentication system receiving the plurality of biometric information; and
the biometric authentication system processing the plurality of biometric information.

8. The method of claim 7, the method further comprising, after processing the plurality of biometric information:
the biometric authentication system storing the biometric information with the user information.

9. The method of claim 7, the method further comprising, after processing the plurality of biometric information:
the biometric authentication system sending the plurality of biometric information for review;
the biometric authentication system receiving an approval or a deletion request; and
the biometric authentication system storing the biometric information with the user information if the approval was received.

10. The method of claim 7, in which the user information further comprises supplemental verification information.

11. A method for registration of an authorized user of a biometric authentication system to create an authentication profile utilizing a user device or an input device, the method comprising:
the user device or the input device sending a request for registration;
the user device or the input device receiving a prompt for user information;
the user device or the input device gathering the user information;
the user device or the input device sending the user information;
the user device or the input device receives a request for biometric information;
the user device or the input device acquiring biometric information; and
the user device or the input device sending the biometric information.

12. The method of claim 11, in which the user information further comprises supplemental verification information.

13. The method of claim 11, the method further comprising, after sending the biometric information:
the user device or the input device receiving processed biometric information; and
the user device or the input device sending an approval or a deletion request regarding the processed biometric information.

14. A method for registration of an authorized user of a biometric authentication system to create an authentication profile utilizing a user device or an input device, the method comprising:
the user device or the input device sending a request for registration to the biometric authentication system;
the biometric authentication system receiving the request for registration;
the biometric authentication system sending a prompt to the user device or the input device for user information;
the user device or the input device receiving the prompt for user information;
the user device or the input device sending the user information to the biometric authentication system;
the biometric authentication system receiving user information;
the biometric authentication system sending a request for a plurality of biometric information to the user device or the input device;
the user device or the input device receiving the request for biometric information;
the user device or the input device sending the biometric information to the biometric authentication system; and
the biometric authentication system receiving the plurality of biometric information.

15. The method of claim 14, in which the user information further comprises supplemental verification information.

16. The method of claim 14, the method further comprising, after the biometric authentication system receiving the plurality of biometric information:
the biometric authentication system sending processed biometric information to the user device or the input device for review;
the user device or the input device receiving processed biometric information;
the user device or the input device sending an approval or a deletion request regarding the processed biometric information to the biometric authentication system; and
the biometric authentication system receiving the approval or the deletion request regarding the processed biometric information.

17. A method for authentication of a registered user of a biometric authentication system utilizing a user device or an input device, the method comprising:
the user activating the biometric authentication system;
the biometric authentication system presenting prompts to the user;
the user commencing an acquisition of user biometric information;
the biometric authentication system obtaining the data derived from the acquisition of the user biometric information;
the biometric authentication system evaluating the acquired user biometric information against stored biometric information; and
the biometric authentication system authenticating the user if the evaluation results of the user biometric information exceed a first certain defined level of statistical certainty.

18. The method of claim 17, the biometric authentication system presenting prompts to the user further comprising:
requiring that the user identify himself or herself prior to commencing the acquisition of user biometric information.

19. The method of claim 17, the method further comprising:
the biometric authentication system requesting supplemental verification information from the user if the evaluation results of the user biometric information exceed a second certain defined level of statistical certainty; and
the biometric authentication system authenticating the user if:
the supplemental verification information matches with a third certain defined level of statistical certainty with supplemental verification information stored with the authentication profile of the user; and
the evaluation results of the user biometric information exceed the second certain defined level of statistical certainty.

20. The method of claim 17, the method further comprising, if the biometric authentication system authenticates the user:
the biometric authentication system granting the user access to the item being secured by the biometric authentication system.

21. The method of claim 17, the method further comprising, if the biometric authentication system does not authenticate the user:
the biometric authentication system exhibiting a message to the user.

22. The method of claim 17, the method further comprising, after the biometric authentication system evaluating the acquired user biometric information, the biometric authentication system alerting to a definable group.

23. A non-transitory computer-readable medium storing instructions for a biometric authentication and registration program causing a computer or electronic processing system to execute:
a step of receiving a request for registration of a user;
a step of processing the request for registration;
a step of generating a prompt for user information;
a step of receiving the user information;
a step of processing the user information;
a step of storing the user information;
a step of requesting biometric information;
a step of receiving the biometric information; and
a step of processing the biometric information.

24. The non-transitory computer-readable medium storing instructions for a biometric authentication and registration program of claim 23, the instructions further comprising instructions causing a computer or electronic processing system to execute:
a step of storing the biometric information with the user information to create an authentication profile related to the user.

25. The non-transitory computer-readable medium storing instructions for a biometric authentication and registration program of claim 23, the instructions further comprising instructions causing a computer or electronic processing system to execute:
a step of sending the processed biometric information for review;
a step of receiving approval or a deletion request regarding the processed biometric information; and
a step of storing the biometric information with the user information to create an authentication profile related to the user.

26. A non-transitory computer-readable medium storing instructions for a biometric authentication and registration program causing a computer or electronic processing system to execute:
a step of activating a biometric authentication system;
a step of presenting prompts to a user;
a step of commencing an acquisition of user biometric information;
a step of obtaining the data derived from the acquisition of the user biometric information;
a step of evaluating the acquired biometric information against stored biometric information; and
a step of authenticating the user if the evaluation results of the user biometric information exceed a first certain defined level of statistical certainty.

27. The non-transitory computer-readable medium storing instructions for a biometric authentication and registration program of claim 26, the instructions further comprising instructions causing a computer or electronic processing system to execute:
a step of requiring the user to identify himself or herself prior to commencing the acquisition of user biometric information.

28. The non-transitory computer-readable medium storing instructions for a biometric authentication and registration program of claim 26, the instructions further comprising instructions causing a computer or electronic processing system to execute:
a step of requesting supplemental verification information from the user if the evaluation results of the user biometric information exceed a second certain defined level of statistical certainty; and
a step of authenticating the user if:
the supplemental verification information matches with a third certain defined level of statistical certainty with supplemental verification information stored with the authentication profile of the user; and
the evaluation results of the user biometric information exceed the second certain defined level of statistical certainty.

29. The non-transitory computer-readable medium storing instructions for a biometric authentication and registration program of claim 26, the instructions further comprising instructions causing a computer or electronic processing system, if the computer or electronic processing system executes a step of authenticating the user, to execute:
a step of granting access to the item being secured.

30. The non-transitory computer-readable medium storing instructions for a biometric authentication and registration program of claim 26, the instructions further comprising instructions causing a computer or electronic processing system, if the computer or electronic processing system does not execute a step of authenticating the user, to execute:
a step of exhibiting a message to the user.

31. The non-transitory computer-readable medium storing instructions for a biometric authentication and registration program of claim 26, the instructions further comprising instructions causing a computer or electronic processing system, after the computer or electronic processing system executes a step of evaluating the acquired biometric information, to execute:
a step of alerting a definable group.
